(19) United States
(12) Patent Application Publication
(10) Pub. No.: US 2021/0406291 A1
(43) Pub. Date: Dec. 30, 2021

(54) DIALOG DRIVEN SEARCH SYSTEM AND METHOD

(71) Applicant: SAMSUNG ELECTRONICS CO., LTD., Suwon-si (KR)

(72) Inventor: Gilles Mazars, Paris (FR)

(21) Appl. No.: 16/997,794

(22) Filed: Aug. 19, 2020

Related U.S. Application Data
(60) Provisional application No. 63/043,622, filed on Jun. 24, 2020.

(51) Int. Cl. G06F 16/332; G06F 40/279; G06F 40/35; G06F 16/33; G06F 16/338; G06F 16/35

(52) U.S. Cl. CPC G06F 16/3329; G06F 40/279; G06F 40/35; H04L 67/1097; G06F 16/338; G06F 16/353; G06F 16/3344

(57) ABSTRACT

A system and method for conducting a dialogue-based search is disclosed. A request for conducting a search for a user is received, and a first intent of the user is classified based on the request. An initial set of information from a knowledge base is identified based on the classified intent. The initial set of information is classified based on at least one criterion, and a question is generated based on the at least one criterion. A response to the question is received from the user, and a second intent of the user is classified based on the response. A subset of the initial set of information is selected based on at least the classified second intent, and an output is provided based on the selected subset.

### CROSS-REFERENCE TO RELATED APPLICATION(S)

The present application claims priority to and the benefit of U.S. Provisional Application No. 63/043,622, filed Jun. 24, 2020, entitled “DIALOG DRIVEN SEARCH ENGINE,” the entire content of which is incorporated herein by reference.

### FIELD

One or more aspects of embodiments according to the present disclosure relate to search systems, and more particularly a search system that conducts dialogue with a user for refining the search results.

### BACKGROUND

There is a lot of information on the world wide web and other domains that a user may want to search to locate information relevant to a current intent. One way of searching a knowledge base (e.g. database of web pages or a catalogue of products) is, for example, by entering a text query to a search engine. The search engine may use the text query to select and score relevant documents from the knowledge base, and display a ranked list of results. The results may be ranked, for example, according to relevance of documents provided in the results.

If the query returns too many results, or results that are irrelevant, the user may attempt to search again by manually refining the initial query. In some instances, the user may navigate through the results using a faceted navigation system. In either scenario, the search engine may provide few, if any, insights to the user on how to refine and continue the search. With such minimal insight, users who are not familiar with a topic being searched may attempt to build knowledge for identifying features that may help refine the search. For example, a user who is unfamiliar with vacuum cleaners may engage in an independent research on important features of vacuum cleaners in order to refine an initial query. In another situation, it may also be hard to refine an initial search query when the user is unsure of the topic that is being searched. For example, a user may want to search for a movie to watch, but may be unsure of the type of movie that he wants to watch.

Accordingly, what is desired is a system and method for searching a knowledge base that guides a user in refining an initial search query to allow the searches to be more efficient.

### SUMMARY

An embodiment of the present disclosure is directed to a method for conducting a dialogue-based search. The method includes receiving a request for conducting a search for a user, and classifying a first intent of the user based on the request. An initial set of information from a knowledge base is identified based on the classified intent. The initial set of information is classified based on at least one criterion, and a question is generated based on the at least one criterion. A response to the question is received from the user, and a second intent of the user is classified based on the response. A subset of the initial set of information is selected based on at least the classified second intent, and an output is provided based on the selected subset.

According to one embodiment, the request includes one or more first keywords, and the response to the question includes one or more second keywords, wherein the classifying of the first intent is based on natural language processing of the one or more first keywords, and the classifying of the second intent is based on natural language processing of the one or more second keywords.

According to one embodiment, the information is represented in a graph having nodes and edges, wherein the initial set of information includes a selected node from the graph.

According to one embodiment, information of the selected node is maintained as context for selecting the subset of the initial set of information.

According to one embodiment, the context includes a score assigned to the selected node, wherein the score of the selected node increases in response to the selected node being included in the subset.

According to one embodiment, the classifying the initial set of information includes clustering the nodes into one or more clusters based on the criterion.

According to one embodiment, the question is based on a characteristic of the one or more clusters.

According to one embodiment, the characteristic includes a size of the one or more clusters.

According to one embodiment, the question is based on a criterion of the at least one criterion that most evenly divides the initial set of information.

An embodiment of the present disclosure is also directed to a system for conducting a dialogue-based search. The system includes a processor; and a memory coupled to the processor, where the memory stores instructions that cause the processor to: receive a request for conducting a search for a user; classify a first intent of the user based on the request; identify an initial set of information from a knowledge base based on the classified intent; classify the initial set of information based on at least one criterion; generate a question based on the at least one criterion; receive a response to the question from the user; classify a second intent of the user based on the response; select a subset of the initial set of information based on at least the classified second intent; and provide an output based on the selected subset.

As a person of skill in the art should recognize, embodiments of the present disclosure provide improvements in knowledge base searching to get a better understanding of a user's intent via an automated dialogue with the user. The improvements in knowledge base searching provide technical improvements such as, for example, reduction in computing cycles in providing a discrete set of relevant search results to the user.

These and other features, aspects and advantages of the embodiments of the present disclosure will be more fully understood when considered with respect to the following detailed description, appended claims, and accompanying drawings. Of course, the actual scope of the invention is defined by the appended claims.

### BRIEF DESCRIPTION OF THE DRAWINGS

Non-limiting and non-exhaustive embodiments of the present embodiments are described with reference to the following figures, wherein like reference numerals refer to like parts throughout the various views unless otherwise specified.

FIG. 1 is a block diagram of a system for conducting a dialogue-based search including a dialogue driven search engine (DDSE) according to one embodiment;

FIG. 2 is a more detailed block diagram of DDSE according to one embodiment;

FIG. 3A is a conceptual layout diagram of a graph that may organize example movie data that may be stored in the knowledge base according to one embodiment;

FIGS. 3B-3D are histograms of the example features and linked nodes of FIG. 3A according to one embodiment;

FIG. 4 is a flow diagram of a process of a dialogue-driven search according to one embodiment;

FIG. 5 is a graphical user interface displaying an example dialogue between a user and a DDSE according to one embodiment; and

FIG. 6 is a graphical user interface displaying another example dialogue between a user and a DDSE according to one embodiment.

### DETAILED DESCRIPTION

Hereinafter, example embodiments will be described in more detail with reference to the accompanying drawings, in which like reference numbers refer to like elements throughout. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described. Unless otherwise noted, like reference numerals denote like elements throughout the attached drawings and the written description, and thus, descriptions thereof may not be repeated. Further, in the drawings, the relative sizes of elements, layers, and regions may be exaggerated and/or simplified for clarity.

In general terms, embodiments of the present disclosure are directed to a system and method for a dialogue driven search engine (DDSE) that interacts with a user to deduce the user intent and identify relevant results from a knowledge base based on the deduced intent. One benefit of the various embodiments is that once an initial search query is input by the user, the user need not manually refine the initial search to further specify his intent. According to one embodiment, questions are automatically posed to the user based on the initial query, and further based on an understanding of features of a domain of the knowledge base. The system may narrow the user's intent based on the user's responses to the posed questions, and identify a discrete set of results that are predicted to satisfy the user's intent with a threshold level of confidence.

According to one embodiment, an understanding of the features of the domain represented in the knowledge base allows the DDSE to efficiently identify information that is predicted to clarify or sharpen the user's intent during the question-answer dialog, while dismissing other information that may not be predicted to satisfy the intent. In this regard, the DDSE may identify an initial set of information in the knowledge base based on identifying the user's intent from the user's initial query. A clustering algorithm may then be invoked for clustering the initial set of information. The clustering algorithm may generate one or more clusters of information for differentiating the information along an identified feature (dimension). A question may then be dynamically generated based on the identified feature.

In one embodiment, the generated question seeks a response from the user for reducing a set of results identified based on the initial search query. In one embodiment, the question that is generated may be for dismissing certain results from the knowledge base (e.g. certain clusters of information) while keeping other results that are likely to answer the user's query. The multi-turn question and answer dialogue between the DDSE and the user may continue until the DDSE reduces the results to a number that is deemed to be adequate to be returned to the user.

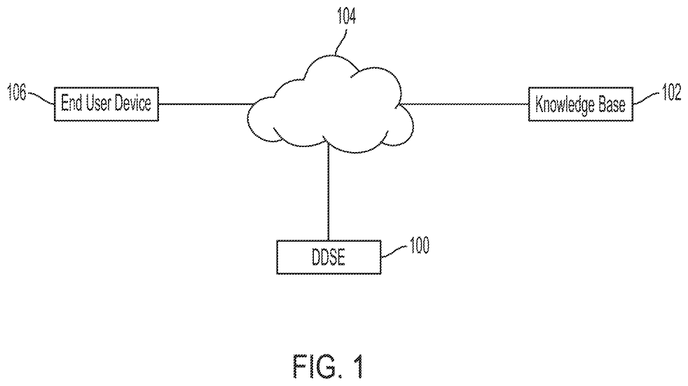

FIG. 1 is a block diagram of a system for conducting a dialogue-based search according to one embodiment. The system includes a DDSE 100 coupled to a knowledge base 102 over a data communications medium 104. The data communications medium 104 may be any wired or wireless communications medium convention in the art. For example, the data communications medium 104 may be a local computer bus of a computing device that hosts the DDSE 100 and knowledge base 102. In embodiments where the DDSE 100 and knowledge base 102 are hosted in separate computing devices, the data communications medium 104 may be a local area network (LAN), private wide area network (WAN), and/or public wide area network such as, for example, the Internet. In some embodiments, the communications medium 104 may include a wireless carrier network including a code division multiple access (CDMA) network, global system for mobile communications (GSM) network, or any wireless network/technology conventional in the art, including but to limited to 3G, 4G, 5G, LTE, and the like.

In one embodiment, the DDSE 100 is configured as a search engine that receives search queries and outputs a discrete set of search results (also referred to as documents) predicted to match the search queries. The search engine may take the form of any computer program that searches and identifies an item of information in the knowledge base(s) 102. The DDSE 100 may be hosted in a stand-alone device such as, for example, an intelligent virtual assistant (e.g. Alexa, Siri, Google Assistant, or the like). The intelligent virtual assistant may also be integrated into an end user device, such as end user device 106. In some implementations, the DDSE 100 is included in a third-party application that communicates with a virtual assistant. In some embodiments, the DDSE 100 may be incorporated into a web browser, web site, and/or the like.

The knowledge base 102 may be a mass storage device that stores information about one or more domains. The mass storage device may take the form of a hard disk or disk array as is conventional in the art. In some embodiments, the mass storage device may be a distributed storage device stored in a remote computing system (e.g. a cloud system). In one embodiment, the information in the knowledge base 102 is organized in a graph database. The graph database may use a graph with nodes and edges to represent the data in the knowledge base. In some embodiments, the knowledge base may comprise a relational database that uses one or more tables made up of rows and columns for organizing the data in the knowledge base. Of course, the present disclosure is not limited to these types of databases, and may encompass other databases conventional in the art. In addition, although text is used as an example of data stored in the knowledge base, the embodiments are not limited thereto, but may encompass any type of data including, for example, images, audio, videos, and the like. The term “document” used herein may therefore be understood to encompass non-text documents.

According to one embodiment, the database hosted by the knowledge base 102 is built based on knowledge provided to the knowledge base. For example, if data is provided as structured data, the data may be translated as table field values for storing in a relational database, or as graph data for storing in a graph database. If the provided data is unstructured data, the data may be divided into one or more documents to be represented by nodes of a graph in the graph database, and relations between the documents may be extracted for forming edges to represent the relationships between the documents. In one embodiment data stored in the relational database is also translated into the graph for easier abstraction.

In one embodiment, a user accesses the search functionality of the DDSE 100 via the end-user device 106. The end-user device 106 may be a communication device conventional in the art, such as, for example, a smart phone, personal computer, electronic tablet, and/or the like. In some embodiments, the end user-device 106 may be the same device as one or both of the DDSE 100 and knowledge base 102. A user operating the end user device 106 may initiate a search request, engage in a dialogue, and receive search results, using one or more communication modalities including voice, chat, text, gestures (e.g. sign language), and the like. For example, when the user engages in a dialogue with the DDSE 100 for further specifying the user's intent, the dialogue may be a text-based chat, text based messages, or a voice conversation. In one embodiment, the DDSE 100 is configured for natural language understanding that enables the DDSE to engage in a natural conversation with the user using the text or voice modalities. In some embodiments, the dialogue between the user and the DDSE may be a structured dialogue. For example, the user may enter an initial query in a text box, and questions following the initial query may be multiple choice questions that the user may select for further defining his intent. In another example, the initial query may be provided in one modality (e.g. voice), and the questions following the initial query may be via a different modality (e.g. text).

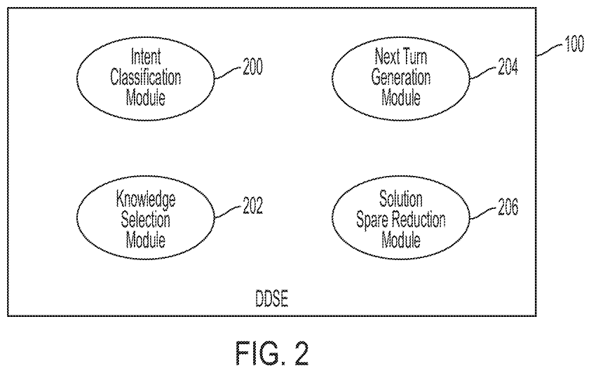

FIG. 2 is a more detailed block diagram of the DDSE 100 according to one embodiment. The DDSE 100 may include one or more modules for engaging in a dialogue-based search based on an initial search query provided by the user. The one or more modules may include an intent classification module 200, knowledge selection module 202, next turn generation module 204, and solution space reduction module 206. Although the one or more modules 200-206 are assumed to be separate functional units, a person of skill in the art will recognize that the functionality of the modules may be combined or integrated into a single module, or subdivided into further sub-modules without departing from the spirit and scope of the inventive concept.

In one embodiment, the intent classification module 200 is configured with natural language processing logic that includes natural language understanding. In this regard, the natural language processing logic may include a lexicon of the language that is to be understood, a parser for parsing a user input, and grammar rules for breaking sentences provided by the user as the user input, into useful representations for understanding an intent of the user. In general terms, natural language understanding may involve part-of-speech tagging (PoS) for defining the function of individual words in the user's input, and syntax and semantic analysis. Syntax analysis may involve parsing the user's input for dividing the input into phrases, and generating, for example, a tree diagram for recognizing and understanding the structure of the input. Semantic analysis may involve disambiguating one or more words in the user's input from a variety of different possible meanings.

In one embodiment, natural language understanding may employ machine learning models such as, for example, BERT (Bidirectional Encoder Representations from Transformers). Such models may help deduce a user's intent by understanding meaning of ambiguous language in the input text by using surrounding text to establish context. For example, invoking natural language understanding may allow identification of a user's intent in the query, “Are there jaguars in the zoo?” to be search for the jaguar animal as opposed to the Jaguar car.

Although various embodiments discussed herein assume that the user's input is unstructured data, it should be appreciated that the input may also be structured input provided, for example, as inputs into preset fields provided by the DDSE 100, answers to multiple choice questions provided by the DDSE 100, and/or the like. In this regard, the intent classification module 200 may be configured to recognize a user's intent from both structured and unstructured data provided by the user during, or before, start of a dialogue with the DDSE 100.

In one embodiment, the knowledge selection module 202 may include logic for retrieving and ranking information in the knowledge base 102. In this regard, the knowledge selection module 202 may be configured to parse nodes of the graph representing the data in the knowledge base, to find the nodes that match a classified user intent. The selection of the nodes may be, for example, based on semantic similarity, casual reasoning, and/or the like. In one embodiment, the knowledge selection module 202 employs a probabilistic retrieval framework such as, for example Okapi BM25, to estimate relevance of the nodes based on the deduced intent. The nodes that are estimated by the knowledge selection module 202 to be relevant, within a threshold level of confidence, may be selected for inclusion into a current solution space.

In one embodiment, the knowledge selection module 202 may be further configured to assign scores to nodes that are selected as matching a current intent. The selected nodes, as well as their scores, may be stored as context data for use in reducing the solution space based on dialog with the user. In one embodiment, when a particular node that was selected in a prior iteration of the search is selected again in a next iteration, the score assigned to the node increases. In this regard, the longer a particular node is maintained in the solution space as other nodes are eliminated based on responses to questions posed by the DDSE 100, the higher the score of the particular node. Information (e.g. score) may be kept for nodes selected in all prior iterations of the search, just a most recent iteration, or a preset number of iterations. For example, weights/scores of prior iterations may be accumulated according to a formula St=x1St-1+x2St-2+x3St-3 . . . +xnSt-n, where St is a current score of the node, St-1 to St-n are the scores for prior iterations, and x1 to xn are values indicative of importance of the prior iterations.

In one embodiment, in addition to information of nodes selected during one or more prior iterations of the search, the knowledge selection module 202 may further be configured to store a global intent (also referred to as a target intent) of the user based on the user's initial search. The global intent may be used during the various iterations of the search for ensuring that the nodes are selected are consistent with the global intent.

In one embodiment, the intent classification and knowledge selection modules 200, 202 may be combined into a single module, allowing the natural language understanding capabilities that may be needed for both intent classification and knowledge selection to be shared. In one embodiment, intent classification may be deemed to be part (e.g. an initial step) of the knowledge selection process.

The next turn generation module 204 may include logic for analyzing one or more results from the knowledge selection module 202, and output a next action to be taken by the DDSE 100. Such an action may be, for example, returning the one or more results as responses to the user query if the results satisfy one or more criteria such as, for example, the number of the results being below a preset number, and confidence level of the results being above a threshold. For example, the next turn generation module 204 (or knowledge selection module 202) may output a matched document (or an extracted portion of the document) to the end user device 106. In one embodiment, the next turn generation module 204 may be configured with natural language generation logic for reformulating the search results prior to output. For example, the natural language generation logic may be invoked to generate a summary of the document for outputting the summary along with the document (or extracted portion thereof).

The number of documents identified by the knowledge selection module 202 may, at times, be greater than a preset threshold number, or their confidence levels below a given threshold, with no clear winner in the identified set for satisfying the user's query. In that case, the next action taken by the next turn generation module 204 may be to select a criterion (e.g. a feature/dimension of the information in the knowledge base), to narrow the identified set of documents. In one embodiment, a clustering algorithm may be employed for identifying features that split the solution space into clusters. The clustering algorithm may assign weights to the features, where the weights may be indicative of the influence of the feature in creating the clusters. In this regard, in one embodiment, the knowledge base may store and pass to the clustering algorithm, information that some features are more important than others (e.g. a ranking of the features). The clustering algorithm may use the information to assign weight to the features during clustering. For example, for movies, the knowledge base may indicate that a “date of release” feature is more important than a “date of shooting” feature, to cause the “date of production” to be given higher weight than the “date of shooting” feature (e.g. double the weight).

The various features, along with their weight values, may be returned to the next turn generation module 204. The next turn generation module 204 may select one or more of the features as the subject of a question to be asked to the user during a next conversation turn. The next turn generation module 204 may invoke its natural language generation logic for generating the question and prompting the user for a response. The response to the question may help clarify the user's intent. For example, if the initial query is, “I need something to wear tonight,” the different types of clothing that match the initial query may be clustered along features such as gender, type of occasion, price range, season, and the like. A response to a question that uses one of the identified features may help narrow the user's intent as to what type of clothing may be desired. Based on such clarification, the clustering algorithm may be invoked again for identifying one or more clusters of information in the solution space that do not help satisfy the user's clarified intent may be eliminated, while one or more other clusters of information that help satisfy the user's clarified intent, may be maintained.

In one embodiment, probability/game theory principles is employed to select a criterion/feature for generating a question for narrowing the solution space. In one embodiment, the selected criterion/feature is a highest weighted feature which also has a highest probability of splitting the solution space substantially evenly (e.g. 50/50 split), so that about 50% of the selected nodes may be eliminated based on the user's response. For example, in the above example of clothing, gender may be a feature that divides the solution space substantially evenly, where half of the clothing nodes in the solution space may be men's clothing, and another half of the clothing nodes may be women's clothing. In this case, a question that uses gender as a subject may maximize a chance of eliminating about 50% of the nodes in the solution space. Other even splits may also be possible. For example, the solution space may be evenly split into three clusters, each cluster containing about 33% of the nodes, or into four clusters, each cluster containing about 25% of the nodes. In one embodiment, the selected criterion may be one that most evenly divides the solution space.

In some embodiments, the selected criterion may one that splits the solution space unevenly. For example, in the above example of clothing, a small handful of clothing nodes may be for a particular designer (e.g. Christian Dior), while the remaining clothing nodes may be for other designers. In this case, a question that may be asked to quickly narrow the user's intent may be, “Are you looking for clothing by Christian Dior?” If the answer is luckily, yes, the user's intent may quickly be deduced with no further questions being needed.

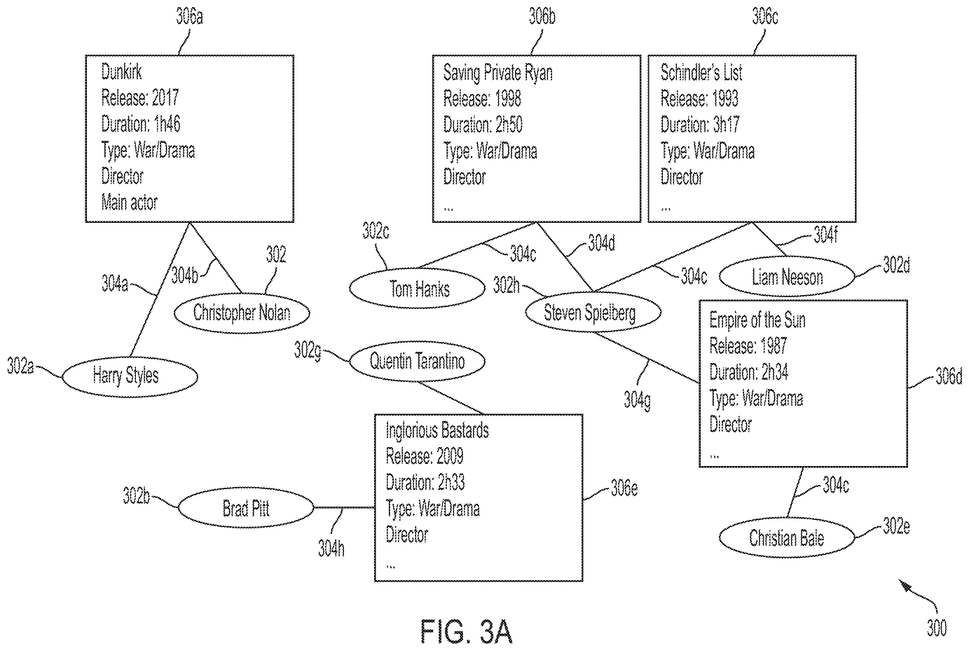

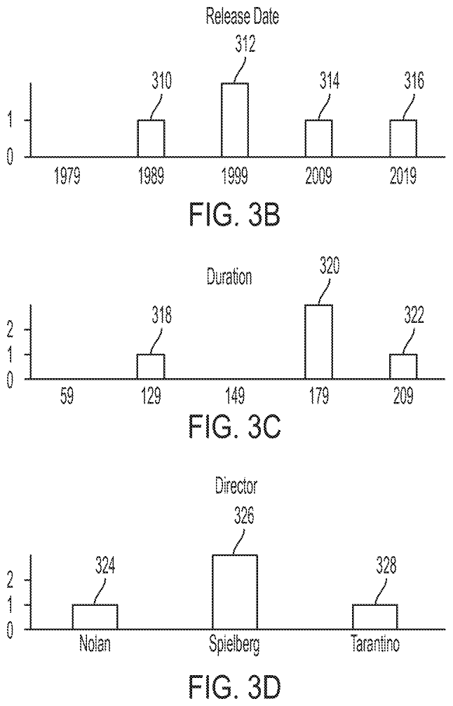

FIG. 3A is a conceptual layout diagram of a graph 300 that may organize example movie data that may be stored in the knowledge base 102 according to one embodiment. The graph 300 includes nodes 302a-302h (collectively referenced as 302), edges 304a-i (collectively referenced as 302), and properties/features 306a-306d (collectively referenced as 306). In the illustrated example, the nodes 302 identify individuals, such as actors 302a-302e or directors 302f-302h. The individuals represented by the nodes 302 are linked to corresponding features/properties 306, via edges 304. The features may identify particular characteristics of the individuals represented by the nodes. In the example of FIG. 3A, the properties include information of movies involving the individual. Such properties may include, for example, movie title, release date, movie duration, movie type, and the like. One or more of the properties may also be represented as one or more nodes of the graph.

In one embodiment, a particular clustering algorithm analyzes the distribution of selected nodes forming a current solution space, and identifies features that help split the solution space into clusters. In this regard, histograms of features and linked nodes may be generated by the clustering algorithm for representing the distribution of the selected nodes according to different features. In one embodiment, the features are ranked according to their contribution in generating the clusters. A feature that generates a desired split of the selected nodes may then be selected for generating a question for the user.

FIGS. 3B-3D are histograms of the example features and linked nodes of FIG. 3A. In one embodiment, the histogram is generated by the clustering algorithm. The histogram of FIG. 3B represents the distribution of movies according to release date, where bins 310-316 represent different release dates that contain movies that fall within the represented date. The histogram of FIG. 3C represents the distribution of movies according to movie duration, where bins 318-322 represent different movie lengths that contain movies that fall within the represented duration. The histogram of FIG. 3D represents the distribution of movies according to movie director, where bins 324-328 represent the different directors in the knowledge base.

In one embodiment, the solution space reduction module 206 may be configured to select a feature that generates a desired split of the selected nodes, using a limited number of bins. For example, if the desired split of the nodes is about 50%, the “director” feature in the histogram of FIG. 3D splits the nodes 60/40, using one bin. In this regard, a single bin 326 associated with director “Spielberg” contains 60% of the movies in FIG. 3A. A single yes or no question directed to this bin may thus allow elimination of roughly half of the movies. The question may be, for example, “Do you like Steven Spielberg?” Based on the user's response, the movies in the “Spielberg” bin may be kept or discarded.

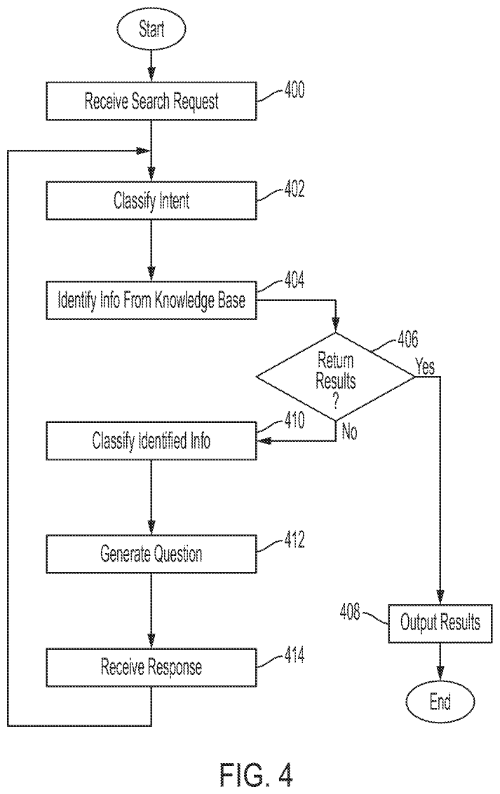

FIG. 4 is a flow diagram of a process of a dialogue-driven search according to one embodiment. It should be understood that the sequence of steps of the process is not fixed, but can be altered into any desired sequence as recognized by a person of skill in the art.

The process starts, and in block 400, the DDSE 100 receives a request from the end user device 106 to conduct a search. The search request may be unstructured data that is provided via text, voice, or a combination of both. The intent classification module 200 may take the search request and parse it for classifying, in block 402, the user's intent. Such intent classification process may invoke a natural language processing logic for understanding the user's intent/goal in submitting the search request.

In block 404, the knowledge selection module 202 scans the graph of the knowledge base 102 for matching the user's intent to information represented as one or more nodes in the graph. In this regard, the knowledge selection module may invoke an information retrieval algorithm to extract features of the nodes, and values of such features, to determine whether the extracted information matches the user's intent. The scanned nodes may be ranked based on a level of confidence that the nodes match the user's intent. Any score value assigned to the nodes may also be considered in ranking the node. For example, the higher the score value, the higher the ranking of the associated node The nodes with a threshold rank may be selected as part of a solution space to be provided to the next turn generation module 204.

In one embodiment, the knowledge selection module 202 is configured to add score values to the selected nodes, and maintain the score values as well as information on the nodes that have been selected, as context information. In one embodiment, the score values assigned to the nodes may depend on a number of times the nodes are selected by the knowledge selection module 202 as the user's intent becomes more and more refined due to the dialogue between the user and the DDSE.

For purposes of illustration, a score of “1” may be assigned to the nodes selected in response to a first iteration of the search, while a score of “10” may be assigned to the nodes selected in the third iteration of the search. In one embodiment, the scores that are assigned during a later iteration of the search are added on top of any previously assigned score. For example, a node selected during the first iteration of the search that is assigned a score of “1”, may be assigned a score of “10,” if the node is selected again during the third iteration of the search, for a total score of 11. In one embodiment, nodes that have scores less a threshold value may be discarded and not included in the solution space.

In block 406, the next turn generation module 204 evaluates the selected nodes in the solution space and determines whether the results should be returned to the user as a final response to the search query. In one embodiment, the next turn generation module 204 determines that the results should be returned if return criteria are satisfied, such as, for example, the number of selected nodes being lower than a threshold number while the confidence level of the node are above a confidence threshold. The threshold number may vary, for example, based on a communication device being used by the user. For example, for a compute web-based result, the threshold number may be 5, while for a mobile phone, the threshold may be 3, and for voice the threshold may be 1 or 2.

If the return criteria is satisfied, the next turn generation module 204 outputs the search results to the end user device 106 in block 408. In some scenarios, a selected node may not be of a type that matches the user's intent, but may be linked to another node that has the requisite type. In this case, a score of the selected node may be propagated to the other node that has correct type, but the particular selected node is not included in the search result.

In one embodiment, next turn generation module invokes the natural language generation logic for generating a summary of the matched information/document(s) represented by the matched nodes, extracting portions of the matched document(s), and/or reformulating the matched document(s), prior to output on the end user device 106. The output provided to the end user device 106 may be in the form of text, audio, or a combination of both.

Referring again to block 406, if the return criteria is not satisfied, the next turn generation module 204 invokes the solution space reduction module 206 for classifying, in block 410, the selected nodes based on at least one criterion. In this regard, the solution space reduction module 206 invokes a clustering algorithm for identifying one or more features that will split the solution space into one or more clusters. The clustering algorithm may assign weights to the identified features indicative of the influence of the features in creating the clusters. In one embodiment, one or more features that have a threshold amount of influence, and which can split the solution space in a particular manner (e.g. evenly), are selected (e.g. by either the solution space reduction module 206 or the next turn generation module 204). Histograms of the identified features may be generated in order to aid the selection of the one or more features. In one embodiment, the one or more selected features are ones that split the nodes with a limited number of bins.

In block 412, the next turn generation module 204 generates a question using the one or more selected features as a subject. In this regard, the module's natural language generation logic is invoked for generating the question as a dialogue between the user and the DDSE 100. In one embodiment, the question is one that maximizes a chance of eliminating about 50% of the selected nodes in the solution space. For example, a selected feature may relate to device type, where the nodes may split substantially evenly between smart watches and smart phones. In this case, the question the next turn generation module 204 may generate may be a “yes” or “no” question with a 50/50 likelihood that the answer will be “yes.” Such a question may be, for example, “Are you interested in smart watches?” The question may be output in the form of text, audio, or a combination of both.

In one embodiment, the question that is output to the user is generated based on a selected template. In this regard, various templates associated with different features may be maintained, and a template corresponding to a selected feature selected for generating the question. For example, for a movie search, templates for features associated with people (e.g. directors or actors), the template may include the question “Do you like X.” A set of template questions may also be maintained for each feature, and an appropriate template question selected based on the selected feature.

In one embodiment, the question that is output to the user is generated based on a machine learning algorithm, such as, for example, a deep neural network algorithm. In this regard, a deep neural network may be trained with different features and questions to be asked based on the different features. The deep neural network may be trained to generate questions based on input features. When in use, the deep neural network may receive as input, one or more features of the selected nodes. Based on the received input, the deep neural network may output a question to be asked to the user for clarifying his intent.

In block 414, the next turn generation module 204 receives the user's answer to the generated question, and loops back to block 402 for determining the user's intent from the received answer. In one embodiment, the determined user' intent is for understanding the answer of the user relative to the feature selected to generate the question, but does not change the original intent of the search. For example, if the user's response to the question as to whether the user is interested in smart watches is “Yes,” the response may be used to narrow the currently selected nodes based on the newly deduced intent that the user is interested in “smart watches.” In this regard, the cluster of nodes associated with smart phones may be discarded, while the cluster of nodes associated with smart watches may be kept, and their score values increased based on an assignment of new score values by the knowledge selection module 202.

In some situations, the user's response to the generated question may not help narrow the solution space. For example, the user's response to a generated question may be, “I don't know.” In this case, a new question may be generated based on, for example, a different feature. The feature may be a next-ranked feature among the features that are deemed to contribute in clustering the selected nodes. The new question may also be generated based on a currently selected feature, but reformulated so as to suggest an answer to the user. For example, the question may be reformulated to correspond to one of the clusters (e.g. the biggest cluster) generated based on the selected feature.

The question-answer dialogue between the DDSE 100 and the user may continue until the selected nodes in the solution space are below the threshold number identified in block 406, and/or at least one of the nodes has a score that satisfies a threshold score. The threshold score may be based on a size of the solution space (e.g. as the solution space decreases, the threshold score may also decrease). In this manner, the user's intent is refined in a user-friendly dialogue with the DDSE, and helps avoid a manual reformulation of the search query based on the user's experience and knowledge on the searched subject.

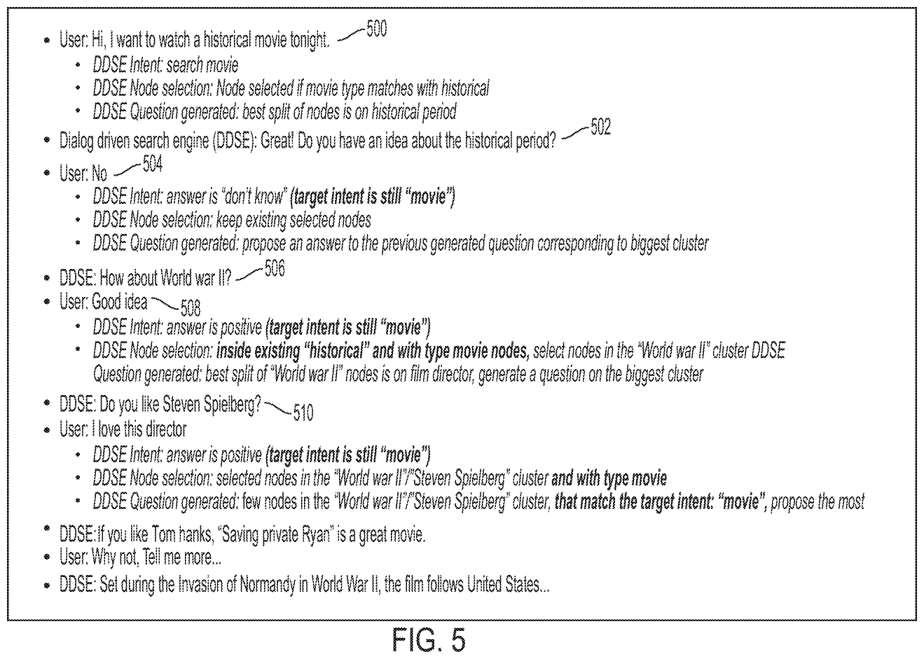

FIG. 5 is a graphical user interface displaying an example dialogue between a user and the DDSE 100 according to one embodiment. In the example of FIG. 5, a user inputs an initial query 500, and the intent classification module 200 classifies the user's intent as a movie search. The global intent may thus be saved as “movie.” The knowledge selection module 202 scans the nodes of the graph in the knowledge base 102, and selects the nodes having a “movie type” feature, set to a value of “historical.”

The next turn generation module 204 detects that the selected nodes are greater than a threshold number, and invokes the solution space reduction module 206 for clustering and splitting the selected nodes. In the example of FIG. 5, the solution space reduction module identifies the “historical period” feature as being one that contributes the most in generating the clusters, and one that helps split the nodes in a desired manner (e.g. 50/50). The next turn generation module 204 generates a question 502 as to whether the user has an idea on the historical period that he might be interested in.

In the example of FIG. 5, the user's response 504 to the question is “No.” Such a response does not provide further information on the user's intent. Thus, the knowledge selection module 202 retains all the selected nodes, and the next turn generation module 204 generates another question for further identifying the user's intent. For example, the next turn generation module may propose an answer to the previously asked question. The proposed answer may point to one of the clusters (e.g. the biggest cluster) generated for the “historical period” feature.

In the example of FIG. 5, the next turn generation module suggests a historical period corresponding to World War II 506. The user's response 508, “Good idea,” is interpreted as a positive response, setting a current user intent to be “World War II.” In response to the new user intent, the knowledge selection module selects the nodes in the World War II cluster, and discards the nodes associated with other historical periods.

In generating a next question to ask the user, the next turn generation module 204 selects a feature that splits the nodes in the World War II cluster, into further clusters. In the example of FIG. 5, the selected feature is “film director.” A next question that is asked to the user is then directed to the subject of film director. The generated next question may solicit the user's preference for one or more of the clustered film directors (e.g. a film director with the most nodes). Such a cluster may be for Steven Spielberg, causing the next turn generation module 204 to ask a question as to the user's preference for Steven Spielberg 510.

Given the positive answer to the generated question, and further given that the movies in the Steven Spielberg cluster is below a set threshold, the DDSE returns the selected movies as a result. In doing so, the DDSE ensures that the results that are output as the final answer match the target intent of “movie.” In this regard, results that are not of type “movie” are discarded from the final output.

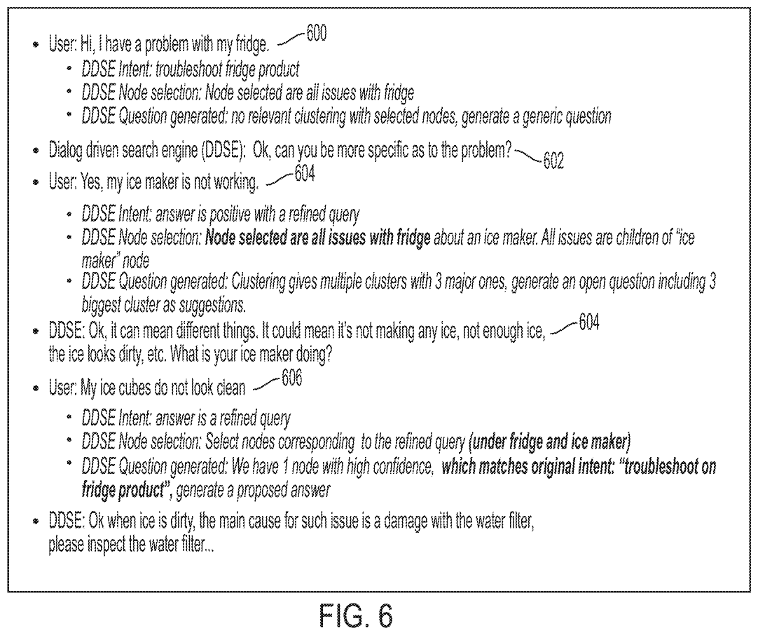

FIG. 6 is a graphical user interface displaying another example dialogue between a user and the DDSE 100 according to one embodiment. In the example of FIG. 6, a user inputs an initial query 600, and the intent classification module 200 classifies the user's intent as troubleshooting a fridge product. The global intent may be saved as “troubleshoot on fridge product.” The knowledge selection module 202 scans the nodes of the graph in the knowledge base 102, and selects the nodes associated with “fridge.”

The next turn generation module 204 detects that the selected nodes are greater than a threshold number, and invokes the solution space reduction module 206 for clustering and splitting the selected nodes. In the example of FIG. 6, the solution space reduction module 206 concludes that no relevant clusters can be formed for the selected nodes. Thus, the next turn generation module 204 generates a generic question 602 for obtaining further information on the user's intent.

In the example of FIG. 6, the user responds 604 to the generic question by stating that the ice maker is not working. The user's intent is set to “ice maker,” and the knowledge selection module identifies, amongst the selected “fridge” nodes, the nodes that relate to “ice maker” for being retained, and discards the nodes associated with other parts of a fridge.

In generating a next question to ask the user, the next turn generation module 204 selects a feature that splits the nodes in the “ice maker” cluster, into further clusters. In the example of FIG. 6, the “ice maker” cluster is clustered into different types of ice maker problems, with three of the problems (represented by three clusters) being prominent. A next question that is asked to the user 604 is then directed to the three prominent clusters.

The user identifies one of the problems in his response 606, setting a current user intent to be “dirty ice cubes.” In response to the new user intent, the knowledge selection module selects the “dirty ice cubes” cluster, and discards the other clusters relating to other problems. In the example of FIG. 6, the “dirty ice cubes” cluster has a single node that is predicted to match the global intent of “troubleshoot on fridge product,” with a threshold level of confidence. The single node is thus selected for output to the user as a response to his search request.

In some embodiments, the DDSE 100 and various modules 200-206 hosted therein, are implemented in one or more processors. The term processor may refer to one or more processors and/or one or more processing cores. The one or more processors may be hosted in a single device or distributed over multiple devices (e.g. over a cloud system). A processor may include, for example, application specific integrated circuits (ASICs), general purpose or special purpose central processing units (CPUs), digital signal processors (DSPs), graphics processing units (GPUs), and programmable logic devices such as field programmable gate arrays (FPGAs). In a processor, as used herein, each function is performed either by hardware configured, i.e., hard-wired, to perform that function, or by more general-purpose hardware, such as a CPU, configured to execute instructions stored in a non-transitory storage medium (e.g. memory). A processor may be fabricated on a single printed circuit board (PCB) or distributed over several interconnected PCBs. A processor may contain other processing circuits; for example, a processing circuit may include two processing circuits, an FPGA and a CPU, interconnected on a PCB.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed herein could be termed a second element, component, region, layer or section, without departing from the spirit and scope of the inventive concept.

The terminology used herein is for the purpose of describing particular embodiments only and is not intended to be limiting of the inventive concept. As used herein, the terms “substantially,” “about,” and similar terms are used as terms of approximation and not as terms of degree, and are intended to account for the inherent deviations in measured or calculated values that would be recognized by those of ordinary skill in the art.

As used herein, the singular forms “a” and “an” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Further, the use of “may” when describing embodiments of the inventive concept refers to “one or more embodiments of the present disclosure”. Also, the term “exemplary” is intended to refer to an example or illustration. As used herein, the terms “use,” “using,” and “used” may be considered synonymous with the terms “utilize,” “utilizing,” and “utilized,” respectively.

It will be understood that when an element or layer is referred to as being “on”, “connected to”, “coupled to”, or “adjacent to” another element or layer, it may be directly on, connected to, coupled to, or adjacent to the other element or layer, or one or more intervening elements or layers may be present. In contrast, when an element or layer is referred to as being “directly on”, “directly connected to”, “directly coupled to”, or “immediately adjacent to” another element or layer, there are no intervening elements or layers present.

Any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein.

Although exemplary embodiments of a system and method for dialogue-based search have been specifically described and illustrated herein, many modifications and variations will be apparent to those skilled in the art. Accordingly, it is to be understood that a system and method for dialogue-based search constructed according to principles of this disclosure may be embodied other than as specifically described herein. The disclosure is also defined in the following claims, and equivalents thereof.

What is claimed is:

1. A method for conducting a dialogue-based search, the method comprising:
receiving a request for conducting a search for a user;
classifying a first intent of the user based on the request;
identifying an initial set of information from a knowledge base based on the classified intent;
classifying the initial set of information based on at least one criterion;
generating a question based on the at least one criterion;
receiving a response to the question from the user;
classifying a second intent of the user based on the response;
selecting a subset of the initial set of information based on at least the classified second intent; and
providing an output based on the selected subset.

2. The method of claim 1, wherein the request includes one or more first keywords, and the response to the question includes one or more second keywords, wherein the classifying of the first intent is based on natural language processing of the one or more first keywords, and the classifying of the second intent is based on natural language processing of the one or more second keywords.

3. The method of claim 1, wherein the information is represented in a graph having nodes and edges, wherein the initial set of information includes a selected node from the graph.

4. The method of claim 3 further comprising maintaining information of the selected node as context for selecting the subset of the initial set of information.

5. The method of claim 4, wherein the context includes a score assigned to the selected node, wherein the score of the selected node increases in response to the selected node being included in the subset.

6. The method of claim 3, wherein the classifying the initial set of information includes clustering the nodes into one or more clusters based on the criterion.

7. The method of claim 6, wherein the question is based on a characteristic of the one or more clusters.

8. The method of claim 7, wherein the characteristic includes a size of the one or more clusters.

9. The method of claim 1, wherein the question is based on a criterion of the at least one criterion that most evenly divides the initial set of information.

10. A system for conducting a dialogue-based search, the system comprising:
a processor; and
a memory coupled to the processor, the memory including instructions that cause the processor to:
receive a request for conducting a search for a user;
classify a first intent of the user based on the request;
identify an initial set of information from a knowledge base based on the classified intent;
classify the initial set of information based on at least one criterion;
generate a question based on the at least one criterion;
receive a response to the question from the user;
classify a second intent of the user based on the response;
select a subset of the initial set of information based on at least the classified second intent; and
provide an output based on the selected subset.

11. The system of claim 10, wherein the request includes one or more first keywords, and the response to the question includes one or more second keywords, wherein the instructions that cause the processor to classify the first intent is based on natural language processing of the one or more first keywords, and the instructions that cause the processor to classify the second intent is based on natural language processing of the one or more second keywords.

12. The system of claim 10, wherein the information is represented in a graph having nodes and edges, wherein the initial set of information includes a selected node from the graph.

13. The system of claim 12, wherein the instructions further cause the processor to maintain information of the selected node as context for selecting the subset of the initial set of information.

14. The system of claim 13, wherein the context includes a score assigned to the selected node, wherein the score of the selected node increases in response to the selected node being included in the subset.

15. The system of claim 12, wherein the instructions that cause the processor to classify the initial set of information include instructions that cause the processor to cluster the nodes into one or more clusters based on the criterion.

16. The system of claim 15, wherein the question is based on a characteristic of the one or more clusters.

17. The system of claim 16, wherein the characteristic includes a size of the one or more clusters.

18. The system of claim 10, wherein the question is based on a criterion of the at least one criterion that most evenly divides the initial set of information.
